(19) United States
(12) Patent Application Publication
(10) Pub. No.: US 2015/0064678 A1
(43) Pub. Date: Mar. 5, 2015

(54) AUDIO COMMAND SYSTEM AND METHOD OF SUPERVISING WORKERS

(71) Applicant: John E. McLoughlin, Hauppage, NY (US)

(72) Inventor: John E. McLoughlin, Hauppage, NY (US)

(21) Appl. No.: 14/019,525

(22) Filed: Sep. 5, 2013

(51) Int. Cl. G09B 5/04

(52) U.S. Cl. CPC G09B 5/04
USPC 434/319

(57) ABSTRACT

An audio command system is provided which allows multiple sets of spoken instructions or commands to be stored in a digital memory and later broadcast to workers in various environments. The system includes a transducer, an analog-to-digital converter, and a voice memory. A control unit is provided for selecting a desired set of commands to be accessed from the voice memory and broadcast to the workers. A method of supervising workers using the audio command includes the steps of converting a plurality of sets of spoken commands into a plurality of sets of digital signals, storing each set of digital signals in a unique location in a memory device, selecting an operation to be performed, accessing the set of stored digital signals corresponding to the selected command set, converting the digital signals corresponding to the selected operation back into spoken commands, and broadcasting the spoken commands to the at least one worker.

### CROSS-REFERENCE TO RELATED APPLICATIONS

This application claims the benefit of U.S. Provisional Application No. 61/697279 , filed on Sep. 5, 2012.

### BACKGROUND OF THE INVENTION

Various situations exist wherein a worker or group of workers must perform a series of steps in a specific order. If any of the steps are omitted or executed out of sequence, the entire operation may fail. For this reason, it is highly desirable to have a supervisor or trainer on site to give verbal instructions for the workers to follow. This is obviously important when the sequence of steps is very complex or when the workers are inexperienced, but even highly seasoned workers performing seemingly simply steps can make mistakes, particularly in emergency situations where there are many distractions. In firefighting, for example, there have been cases of pumps failing to operate because of a firefighter forgetting just one step.

Unfortunately, it is not always possible for a supervisor to oversee every step of every operation performed by workers in every situation. Accordingly, there exists a need for an audio command system that can instruct workers when a supervisor is not available.

### SUMMARY OF THE INVENTION

Briefly, to achieve the desired objects of the invention , an audio command system is provided which allows multiple sets of spoken instructions or commands to be stored in a digital memory and later broadcast to workers in various environments. The system comprises transducer means such as a speaker/microphone which converts multiple sets of spoken commands into analog electrical signals, an audio input device which converts the analog electrical signals into digital signals, and a voice memory which stores the digital signals until needed. Control means are provided for selecting a desired set of commands to be accessed from the voice memory and broadcast to at least one worker.

A method of instructing workers using the audio command system is also described. The method comprises converting a plurality of sets of spoken commands into a plurality of sets of digital signals, storing each set of digital signals in a unique location in a memory device, selecting an operation to be performed, accessing the set of stored digital signals corresponding to the selected command set, converting the digital signals corresponding to the selected operation back into spoken commands, and broadcasting the spoken commands to the at least one worker.

In a further and more specific aspect of the inventive method, each set of spoken commands is given a name which is recited before the associated set of commands is recited. When the system in output mode, an operator actuates a first switch to select the name of a desired command set, causing the name to be broadcast from the system. After hearing the name and verifying that it corresponds to the correct command set, the operator actuates a second switch to allow all of the commands in the set to be broadcast. The entire process may then be repeated for many different command sets corresponding to various different operations that the workers need to perform.

### BRIEF DESCRIPTION OF THE DRAWINGS

The foregoing and more specific objects and advantages of the instant invention will become readily apparent to those skilled in the art from the following detailed description of the preferred embodiments thereof taken in conjunction with the drawings in which:

FIG. 1 is a schematic view of an audio command system according to the present invention; and

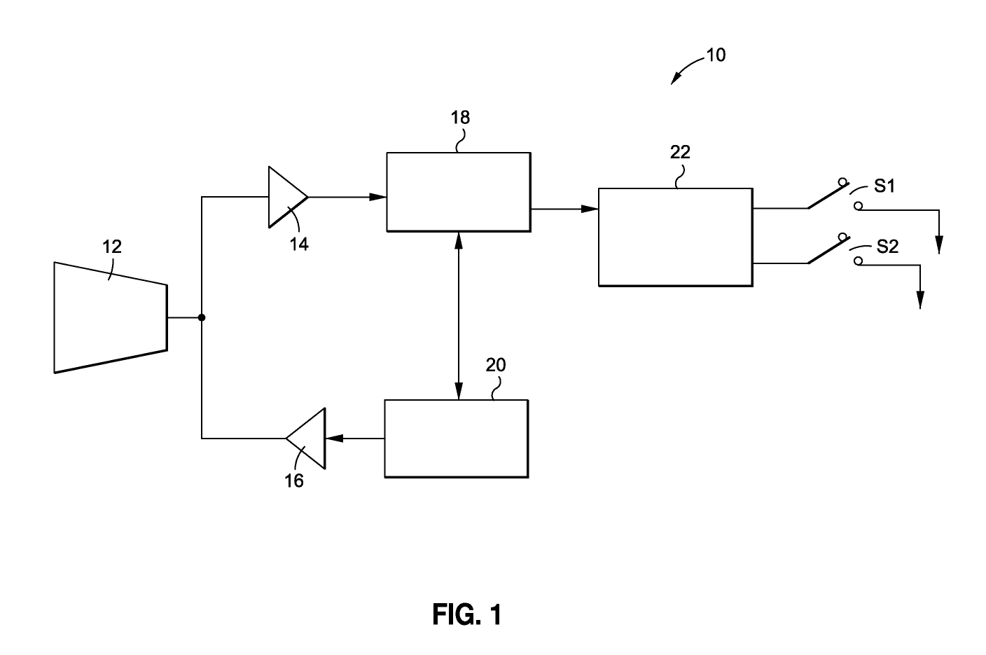

FIG. 2 is a flow chart showing a sequence of steps executed by the audio command system.

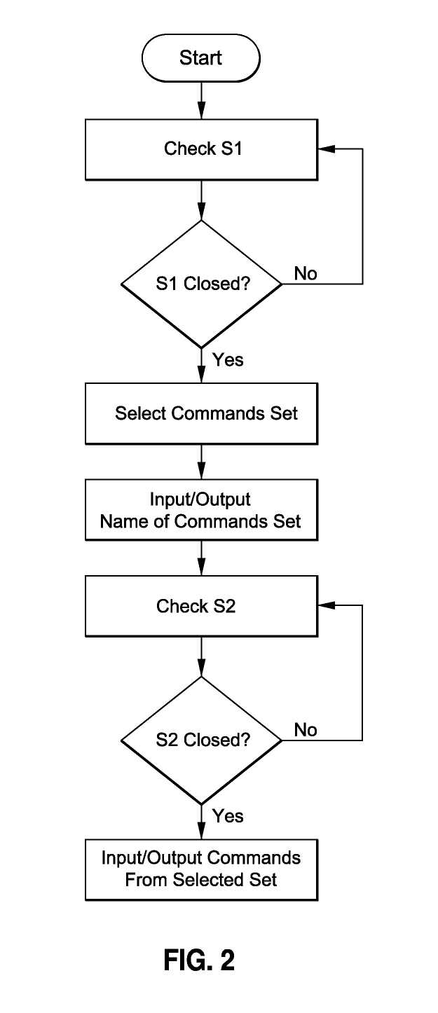

### DESCRIPTION OF THE PREFERRED EMBODIMENTS

The audio command system of the present invention, indicated in its entirety by the numeral 10, comprises audio transducer means 12, an analog-to-digital converter (ADC) or audio input device 14, a digital-to-analog converter (DAC) or audio output device 16, a voice memory 18, memory 20, a control processor 22, and control switches S1 and S2.

The audio transducer means may comprise any device or set of devices for converting sound waves to and from electrical signals such as, for instance, a combination speaker/microphone, separate speakers and microphones, a headset, or the like.

The system has two modes of operation: input mode and output mode. Input mode allows recording of an operator's voice and output mode allows the recorded voice to be played back.

The voice memory 18 is capable of storing up to a predetermined maximum number X of vocal command sets, each of which consists of up to a predetermined maximum number Y of vocal commands recited in a specific sequence. Switch S1 allows an operator to choose a command set and switch S2 allows the commands within the selected set to be input to or output from the system 10.

The specific command sets and commands may vary depending on the application, but for firefighting applications, examples of typical command sets are “pump operations”, “lighting operations”, and “hydraulic operations.” Typical commands within a command set such as “pump operations” are “put the transmission in neutral”, “activate the air brake”, “actuate the pump”, “put the transmission in drive”, “step on the accelerator,” and so forth.

When the system 10 is in input mode, an operator actuates switch S1 to select the name of a desired command set such as “pump operations,” and then speaks the name into the audio transducer means 12 which converts the operator's voice into analog electrical signals which are subsequently converted into digital signals by the ADC 14. These digital signals are then stored in a unique location in the voice memory 18.

Next, the operator actuates switch S2 and recites the entire list of commands within the selected set. The transducer means 12 converts the acoustic waves from the spoken commands into a set of analog electrical signals that are converted into a set of digital signals. The set of digital signals is stored in another unique location in the voice memory 18.

The process of inputting operation names and command sets can then be repeated X-1 times.

When the system 10 is in output mode, the operator actuates switch S1 to select the desired command set. The name of the set is then retrieved from the memory 20 and converted into audio signals by the DAC 16, which then outputs the name of the set through the audio transducer means 12, confirming that the correct set has been chosen. The operator then actuates switch S2 so that all of the commands in the set are output through the speaker.

The audio command system of the present invention is ideal for use on emergency vehicles such as fire trucks and ambulances, but is also suitable for use on non-emergency vehicles and innumerable other environments.

Various modifications of the invention will readily occur to the skilled practitioner. To the extent that such modifications do not depart from the spirit of the invention, they are intended to be included within the scope thereof.

Having fully described the invention in such clear and concise terms as to enable those skilled in the art to understand and practice the same, the invention claimed is:

1. An audio command system comprising:
a) audio transducer means for converting sets of acoustic signals to and from sets of analog electrical signals;
b) audio input means for receiving said sets of analog signals from said audio transducer means and converting said sets of analog electrical signals into sets of digital electrical signals;
c) storage means for storing said sets of digital signals;
d) audio output means for receiving said sets of digital signals from said storage means, converting said sets of digital signals into sets of analog signals, and transmitting said sets of analog signals to said audio transducer means; and
e) control means for assigning a unique name to each set of signals, assigning each named set a unique location in the storage means, and allowing an operator to select a named set to be output from the system.

2. The audio command system according to claim 1, wherein said audio transducer means comprise a combination speaker/microphone.

3. The audio command system according to claim 1, wherein said acoustic signals comprise verbal commands.

4. A method of supervising at least one worker, comprising:
a) converting a plurality of sets of spoken commands into sets of digital signals, each set of spoken commands and its associated digital signals corresponding to a different operation to be performed by the at least one worker;
b) storing each set of digital signals in a unique location in a memory device;
c) selecting an operation to be performed;
d) accessing the set of stored digital signals corresponding to the selected operation;
e) converting the digital signals corresponding to the selected operation back into spoken commands; and
g) broadcasting the spoken commands to the at least one worker.

5. The method of claim 4, wherein converting the plurality of sets of spoken commands into sets of digital electrical signals comprises:
a) inputting said spoken commands into an audio transducer; and
b) converting analog electrical signals from said audio transducer into digital electrical signals.

6. The method of claim 5, wherein inputting said spoken commands into an audio transducer comprises speaking into a microphone.

7. The method of claim 4, wherein converting the digital signals corresponding to the selected operation back into spoken commands comprises:
a) converting said digital electrical signals to analog electrical signals; and
b) converting said analog electrical signals into acoustic signals.

8. The method of claim 7, wherein converting said analog electrical signals into acoustic signals comprises inputting said electrical signals into an audio transducer.

9. The method of claim 8, wherein broadcasting said commands comprises outputting acoustic signals from said audio transducer.

10. The method of claim 9, wherein said audio transducer is a speaker.

11. The method of claim 6, wherein said microphone is a combination speaker/microphone.

12. The method of claim 10, wherein said speaker is a combination speaker/microphone.

13. The method of claim 5, wherein inputting said spoken commands comprises:
a) actuating a first switch to prepare the memory device to receive signals corresponding to a name of an operation to be performed by the at least one worker;
b) stating the name of said operation;
c) actuating a second switch to prepare the memory device to receive and store signals corresponding to a series of commands associated with said operation;
d) reciting the series of commands; and
e) repeating steps a-d for each operation to be performed.

14. The method of claim 13, wherein the steps of selecting an operation to be performed, accessing the set of stored digital signals, and broadcasting the commands comprise:
a) actuating the first switch to allow access to a list of all the operation names stored in the memory;
b) selecting the name of the desired operation from the list;
c) broadcasting the name of the selected operation;
d) actuating the second switch to allow the signals corresponding to the series of commands associated with the selected operation to be accessed from the memory; and
e) broadcasting the series of commands associated with the selected operation.
